(19) United States
(12) Patent Application Publication
(10) Pub. No.: US 2025/0354337 A1
(43) Pub. Date: Nov. 20, 2025

(54) METHOD AND TOOL FOR PRODUCING A BREAKABLE WEAK POINT IN MOLDED BODIES MADE OF FIBER-CONTAINING MATERIAL AND MOLDED BODIES MADE OF FIBER-CONTAINING MATERIAL HAVING A BREAKABLE WEAK POINT

(71) Applicant: Kiefel GmbH, Freilassing (DE)

(72) Inventors: Richard Hagenauer, Saaldorf-Surheim (DE); Jakob Kirchleitner, Teisendorf (DE)

(21) Appl. No.: 19/206,376

(22) Filed: May 13, 2025

(30) Foreign Application Priority Data
May 17, 2024 (DE) 10 2024 113 900.5

(51) Int. Cl. D21J 1/02; D21J 1/04; D21J 3/00

(52) U.S. Cl. CPC D21J 1/02; D21J 1/04; D21J 3/00

(57) ABSTRACT

A method for producing a breakable weak point in molded bodies made of fiber-containing material is described. Further, a tool for producing a breakable weak point in molded bodies made of fiber-containing material is described. A molded body made of fiber-containing material is also described. The molded body has at least one surface portion that has at least one region with a breakable weak point.

### PRIORITY CLAIM

The present application claims priority under 35 U.S.C. § 119 to German Patent Application No. DE 10 2024 113 900.5, filed May 17, 2024, the disclosure of which is incorporated by reference herein in its entirety.

### TECHNICAL FIELD

A method for producing a breakable weak point in molded bodies made of fiber-containing material, a tool for producing a breakable weak point in molded bodies made of fiber-containing material, and a molded body made of fiber-containing material are described, said molded body having at least one surface portion that has at least one region with a breakable weak point.

### BACKGROUND

Fiber-containing materials are increasingly used, for example, to produce packaging for food (such as trays, capsules, boxes, etc.) and consumer goods (such as electronic devices, etc.) as well as beverage containers. The fiber-containing materials can have natural fibers, which are obtained, for example, from renewable raw materials or waste paper. The natural fibers can be mixed in a so-called pulp with water and, optionally, further additives, such as starch, and then formed. Additives can also have an effect on color, barrier properties, and mechanical properties. A pulp can have a proportion of natural fibers of, for example, 0.1 to 10 wt. %. The proportion of natural fibers can vary according to the method used for the production of packaging, etc., and the product properties of the product to be produced. Fibers, such as natural fibers, can also be introduced into forming tools in a dry state and processed or formed therein. Alternatively, such fibers can be processed into starting materials for subsequent shaping. Starting materials for further processing can, for example, be so-called webs or sheets, such as airlaid, fluff pulp, paper, etc., as well as multi-layer arrangements made of the above materials, made of a fiber-containing material, which are then formed in a forming tool.

Production processes for products or molded bodies made of a fiber-containing material involve a wet process, where the molded bodies are pressed from fibers that are drawn out of an aqueous suspension and pressed to form finished molded bodies in one or more process steps under heat and pressure. Another method relates to a dry process, where a relatively loose fiber composite (e.g., airlaid) with a low moisture content is pressed under high pressure and heat to form finished molded bodies.

When using fiber-containing products or molded bodies, e.g., as lids or the like, a local weak point is often required that can be easily broken. The weak point must be designed in such a way that, when not opened, it has a sufficient sealing effect against external and internal influences (e.g., liquids, dust, etc.) on the weak point. In addition, the weak point must be easy to open. For example, this is to be possible with a straw. Further embodiments may, for example, have a foldable lip or the like that is partially connected to an adjacent region and, after separating a part thereof, can be tilted around a portion rigidly connected to the region in order to release a drinking opening. Such weak points are also necessary for coffee capsules made of fiber-containing material in order to enable the capsules to be pierced without the entire structure of the capsule being damaged due to the fiber-containing material.

One possibility is perforation, where small, fully punched regions are separated by ridges arranged in-between. In this case, a complete barrier or seal is not achieved in the region of the punched regions. Another possible way of reducing the layer thickness in the region of a weak point has the disadvantage that, when the weak point is penetrated, the weak point tears due to the fiber-containing material, because the fibers extend over the weak point in the remaining connected region, such that the region around the weak point is severely damaged. Since the orientation of fibers and the type of fibers (e.g., fiber length) can differ each time for a plurality of molded parts, it is thus also not possible to keep the effects on the weak points and thus tearing constant for a plurality of molded bodies when the weak points are penetrated. Furthermore, such a reduction in layer thickness can only be achieved with a great amount of effort. This particularly involves adhering to layer thicknesses such that the weak point can be penetrated with a defined amount of force, and at the same time the weak point is sufficiently stable.

However, the designs known from the prior art for such weak points in molded parts made of a fiber-containing material have the disadvantage that they can either be opened easily, but above all do not provide a secure sealing effect and barrier, or they provide a sufficient sealing effect, but are very difficult to open.

### SUMMARY

### Object

Thus, it is an object to provide a solution that eliminates the disadvantages of the prior art and provides a solution for breakable weak points in molded bodies made of fiber-containing material that are simple, have sufficient barrier and sealing properties, and can be easily opened without causing damage to the molded parts. In addition, it is an object to provide a weak point that is reproducible, such that a plurality of molded parts with the same properties can be produced, in particular in the region of the weak point.

### Solution

The aforementioned object is achieved by a method for producing a breakable weak point in molded bodies made of fiber-containing material, where the method involves the following steps:
providing a molded body made of a fiber-containing material having at least one surface portion,
completely cutting at least one region of the at least one surface portion, and
pressing the at least one previously completely cut region of the at least one surface portion, where the fiber-containing material in the at least one cut region is pressed against each other, and thereby a connection is created in the at least one region that is weaker than the connection of the fiber-containing material in the remaining region of the at least one surface portion.

In the method, the fiber-containing material is pressed together on opposite surfaces at a separation point (e.g., cut surfaces) of the at least one region after it has been completely cut, where a force-fitting connection between the opposite surfaces is created in the region of the separation point, forming the breakable weak point. A breakable weak point can in particular be pierceable such that, for example, it can be pierced using a straw or the like. Pressing the previously completely cut region creates a weak point that is sufficiently strong to prevent unwanted penetration of materials, etc., and at the same time can be easily broken or pierced without damaging the surface portion around the at least one region with the weak point. Fibers of the fiber-containing material of the separated points are not integrally bonded in the finished weak point after pressing.

In other embodiments, the molded body can include only of the fiber-containing material and, for example, not be laminated, etc. The surface portion can also be flat or curved, where the at least one region can follow the course of the surface portion.

Compared to known embodiments, weak points are easy to produce, and this enables the provision of a plurality of molded bodies having the same properties in the region of the weak point. In particular, the weak points of all molded bodies exhibit the same behavior during breaking or piercing, and do not damage the surface portion and the at least one region.

The process of cutting the at least one region and the process of subsequently pressing the at least one region are easy to implement.

The at least one region itself can be designed to be at least partially straight, curved, round, angular, etc.

In further embodiments, the layer thickness of the fiber-containing material can be reduced in the at least one region. The layer thickness can be reduced during pressing such that the force on the opposite surfaces in the region of the separation point is increased. A suitable pressing tool with a sufficiently large pressing surface can ensure that the fiber-containing material does not move out the way thereof during pressing. This means that the alignment and course of the surface portion can be maintained even during pressing. In addition, the layer thickness of a portion next to the at least one region can be reduced.

In further embodiments, the pressing process does not produce an integral bond between fibers of the fiber-containing material in the at least one region.

In further embodiments, pressing can take place at a temperature in the range of 1 to 250° C. Preferably, pressing can be carried out at or above approximately room temperature, e.g., 20° C.

In further embodiments, pressing can be carried out at a pressure in the range of 1 to 250 N/mm², in particular in the range of 100 to 200 N/mm².

In further embodiments, a plurality of regions in the at least one surface portion can be cut, where the plurality of regions are separated from one another by fiber-containing material that is not cut. In this case, ridges or micro-connections can remain between the completely cut regions, which give the cut regions sufficient stability and can also carry forces beyond the weak point.

In further embodiments, the plurality of regions and the fiber-containing material separating the plurality of regions from one another can be pressed together, where they can be collectively pressed such that the fiber-containing material between the separated regions is also pressed.

In further embodiments, the at least one region and/or the at least one surface portion can be laminated after being pressed, in order to provide an additional coating for a barrier, etc.

In further embodiments, the provision of the molded body may additionally include a production step, where fiber-containing material is formed into a molded body. Such a production step precedes the formation of the molded body and can, for example, be carried out in a common facility. Alternatively, the molded body can be produced in advance and then fed to a device for producing weak points. The production step may, for example, involve forming molded bodies from a pulp or from a relatively dry material (e.g., airlaid, etc.).

In further embodiments, the at least one region can be moistened after the at least one region has been cut and before the at least one region has been pressed. Moistening can have a positive effect on the subsequent pressing process, e.g., such that the separated surfaces are subjected to greater compression and thus pressure (greater force-fitting connection), since moister materia|-depending upon the type and processing of the material—can be pressed more easily. There is no integral connection, and therefore the advantage of the force-fitting connection of the weak point is retained.

In further embodiments, the at least one region can be cut and/or pressed on opposite sides of the at least one surface portion. The layer thickness can also be reduced on both sides.

In further embodiments, a pattern spanning the at least one cut region can be stamped into a surface on at least one side during pressing. In further embodiments, stamping can be carried out at the same time as pressing. The pattern can strengthen the connection in the weak point because, on the one hand, further partial strengthening is achieved by stamping patterns penetrating deeper into the fiber-containing material, and, on the other, when pressing opposite surfaces, pressing can take place in a further orientation or direction in the separation point.

The aforementioned object is further achieved by a tool for producing a breakable weak point in molded bodies made of fiber-containing material, having at least one cutting element and at least one punch, where the at least one cutting element is received in the at least one punch and is displaceable relative to the at least one punch, where, in order to produce a breakable weak point, the at least one cutting element and the at least one punch are collectively displaceable and the at least one cutting element protrudes from the at least one punch, where, after at least one region of a fiber-containing material has been cut by the collective displacement of the at least one cutting element and the at least one punch, the at least one cutting element can be held on at least one stop such that, upon further displacement of the at least one punch, a pressing surface of the at least one punch can be pressed against the at least one region, and the at least one cutting element plunges into the at least one punch.

The design of the tool as a combined cutting and pressing device enables fiber-containing material to be cut in at least one region, and the at least one cut region to be pressed in one work step. The at least one punch and the at least one cutting element are coupled to one another in such a way that, when the tool is closed, the fiber-containing material is first cut in at least one region, and, upon further movement in the closing direction, the previously cut region is pressed. For this purpose, the at least one cutting element can plunge into the at least one punch and is mounted in the punch, e.g., by means of a spring element, such that the cutting element can be automatically pressed into a receptacle of the punch when a lower end position is reached. The end position can be reached, for example, when the cutting element has completely cut through the fiber-containing material and comes into contact with a counter-position of the tool, which also serves as a stop for the cutting element.

The aforementioned object is also achieved by a molded body made of fiber-containing material, having at least one surface portion, where the at least one surface portion has at least one region with a breakable weak point, where the breakable weak point has a separation point with opposite surfaces, where the opposite surfaces of the separation point are produced by separating the fiber-containing material, and where the fiber-containing material is force-fittingly interconnected at the surfaces of the separation point.

The formation of the weak point provides sufficient tightness, and it can, at the same time, be easily opened without damaging or destroying the surface portion surrounding the at least one region. With regard to the advantages and embodiments of the molded body, reference is also made to the explanations regarding the production of a weak point and the tool used therefor.

In further embodiments, the at least one surface portion in the region with the breakable weak point can have a smaller layer thickness than adjacent regions of the at least one surface portion.

In further embodiments, the fiber-containing material can furthermore be subject to greater compression in the region of the breakable weak point than in adjacent regions of the at least one surface portion.

Further features, embodiments, and advantages result from the following illustration of exemplary embodiments with reference to the figures.

### BRIEF DESCRIPTION OF THE FIGURES

### in the Figures:

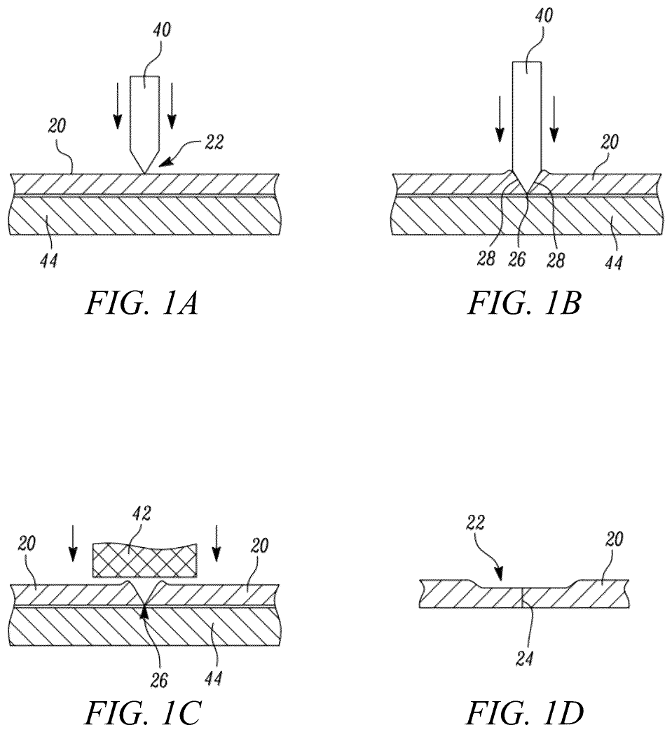

FIGS. 1A-D depict schematic representations of the production of a weak point in a region of a surface portion of a molded body;

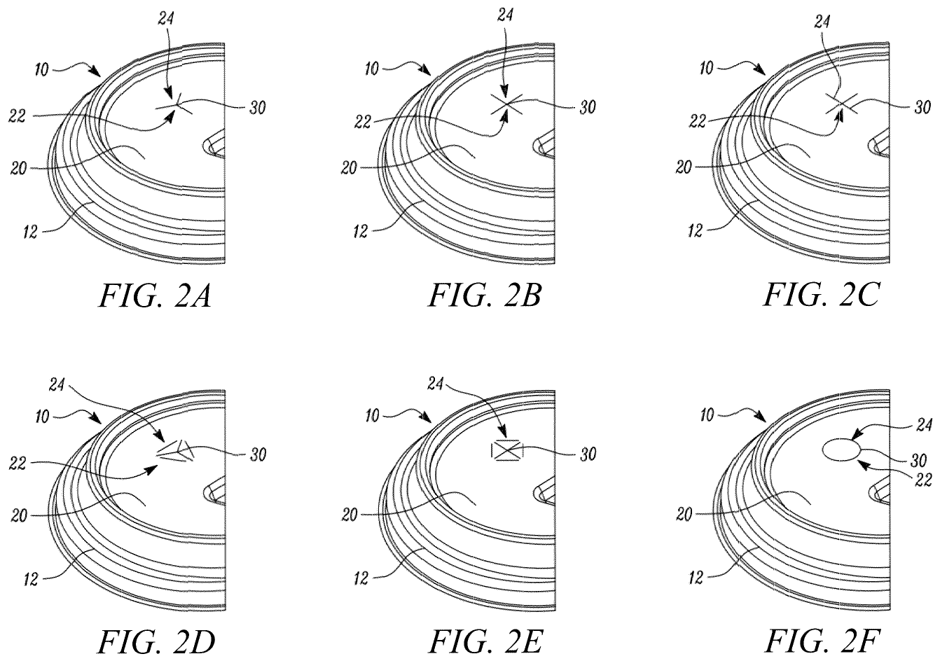

FIGS. 2A-F depict schematic representations of the formation of weak points in molded bodies;

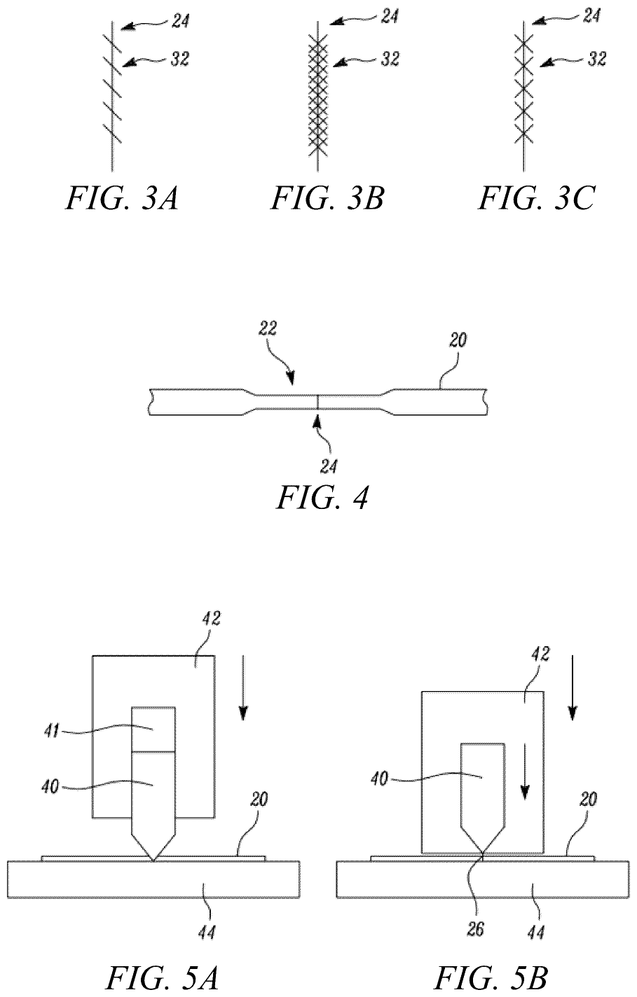

FIGS. 3A-C depict schematic representations of a weak point with an imprint;

FIG. 4 depicts a schematic sectional representation of a weak point;

FIGS. 5A-B depict further schematic representations of the production of a weak point in a region of a surface portion of a molded body;

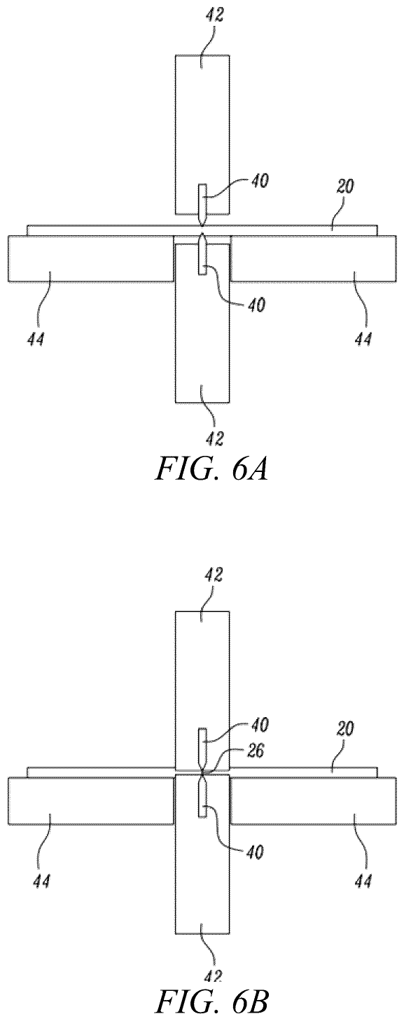

FIGS. 6A-B depict yet further schematic representations of the production of a weak point in a region of a surface portion of a molded body; and

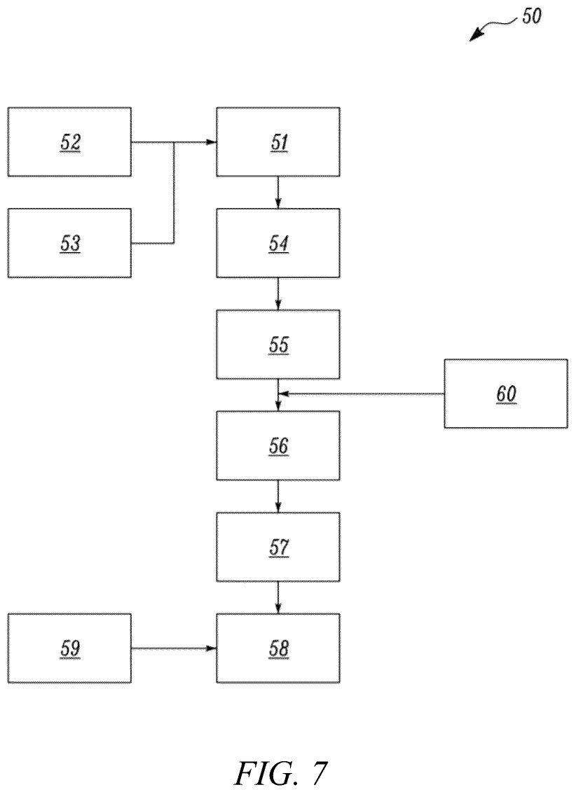

FIG. 7 depicts a schematic representation of a method for producing breakable weak points in molded bodies made of a fiber-containing material.

### DETAILED DESCRIPTION

Various embodiments of the technical teaching described herein are shown below with reference to the figures. Identical reference signs are used in the figure description for identical components, parts, and processes. Components, parts, and processes that are not essential to the technical teachings disclosed herein or that are obvious to a person skilled in the art are not explicitly reproduced. Features specified in the singular also include the plural unless explicitly stated otherwise. This applies in particular to statements such as “a” or “one.”

FIGS. 1A-D depict schematic representations of various steps in the production of a weak point 24 in a region 22 of a surface portion 20 of a molded body 10 made of a fiber-containing material. Molded bodies 10 can, for example, be formed from a fiber-containing suspension (pulp) in a preceding production step. Alternatively, molded bodies 10 may be formed from a paper-like sheet having at least one layer. In a molding process, molded bodies 10 can be made into a three-dimensional shape and cured. The molded bodies 10 can, for example, be shaped as a lid, as shown in FIGS. 2A-F. However, molded bodies 10 can also be formed into other shapes and form, for example, cups, bowls, capsules, etc.

After the provision of molded bodies 10, surface portions 20 can be provided with a weak point 24. Surface portions 20 can be located, for example, on flat regions of the material or on curved regions of the material. The formation of weak points 24 is not subject to any restrictions with regard to the surface structure of the material. To do this, it is only necessary to adapt the tool to produce weak points 24 or to design the tool accordingly.

FIG. 1A is a schematic representation of a first production step for the production of weak points 24 in a surface portion 20 of a molded body 10 made of a fiber-containing material. In the exemplary embodiment shown, a detail of the molded body 10 is depicted. The molded body 10 may, for example, be a lid that is designed as shown in FIGS. 2A-F. The weak point 24 is created in a flat surface portion 20. For this purpose, the molded body 10 is placed on a tool part that serves as a counter-support 44. The counter-support 44 or the tool part can be made of a suitable material, in particular a metal or a metal alloy, or can have a metal or a metal alloy at least on the surface for supporting the surface portion 20. The counter-support 44 can completely reproduce the geometry of the molded body 10, such that the entire lower surface of the molded body 10 is in contact with the counter-support 44. In further embodiments, the counter-support 44 can extend substantially over the region in which the weak point 24 is formed.

FIG. 1A depicts the surface portion 20 made of fiber-containing material of a molded body 10, which rests on the counter-support 44, at least in one region 22. To produce the weak point 24 in the region 22, a punching knife 40, which serves as a cutting element, is first positioned and then lowered from above in the direction of the arrows. The design of the punching knife 40 defines the width and length of a cut through the fiber-containing material after punching. In further embodiments, a plurality of punching steps can be carried out one after the other and/or using punching knives 40 arranged one behind the other or next to one another, in order to produce, for example, cuts in the fiber-containing material that are very long and/or have a curved, closed, and/or “perforated” form. A perforated form includes, for example, designs with a plurality of completely cut regions separated by ridges 30, where the fiber-containing material in the region of the ridges 30 is not cut or is only partially cut. For instance, the layer thickness of the fiber-containing material in the region of the ridges 30 can be reduced with respect to the fiber-containing material in the rest of the surface portion 20.

FIG. 1B depicts a state in which the punching knife 40 has completely cut the fiber-containing material in the region 22. The lower, pointed cutting edge of the punching knife 40 strikes the counter-support 44 and cannot be moved any further. The fiber-containing material in the separation point 26 is pushed to the side, such that a slight accumulation of material can occur in the region 22 because it cannot move out the way, either downwards or to the side, or this is only possible to a limited extent. The accumulation shown in the separation point 26 is the simplest alternative for the material.

After separation, the fiber-containing material in the separation point 26 has opposite surfaces 28 that are completely separated from one another and no longer have an integral bond.

As depicted in FIG. 1C, there is a gap between the surfaces 28 in the separation point 26 after punching. Substances, liquids, etc., can pass through the gap via the weak point 24. Therefore, a punch, which in the embodiment shown is a stamping punch 42, is positioned relative to the separation point 26 and moved in the direction of the arrows towards the gap or the separation point 26. The stamping punch 42 can have a lower stamping surface that extends at least over the length and width of the separation point 26 or the gap. In the embodiment shown, the stamping punch 42 has a width that extends laterally at least 3 to 10 mm beyond the separation point 26 in both directions. In the longitudinal direction, e.g., in the direction in the drawing, the stamping surface of the stamping punch 42 can extend beyond the separation point 26 to the same extent—by at least 3 to 10 mm.

In the exemplary embodiment shown, the stamping surface of the stamping punch 42 is flat, such that the surface portion 20 can be pressed together with the separation point 26 in the region 22 over a definable stamping region, which is defined in accordance with the stamping surface of the stamping punch 42. During pressing, the stamping punch 42 is pressed against the region 22 until a force-fitting connection is formed between the surfaces 28 in the separation point 26, closing the gap. In the embodiments shown, the stamping region, e.g., the region of the fiber-containing material that is pressed, extends beyond the separation point 26. This also presses the accumulation of material in the region of the separation point 26, such that no accumulation remains after pressing, due to the separation or cut.

In further embodiments, for example, cuts with closed structures (e.g., circular weak points 24; see, for example, FIG. 2F can have only a lateral extension of the stamping surface of a stamping punch. The correspondingly pressed surface of the surface portion 20 can, in the embodiment of a weak point 24 as a closed structure, thus extend, for example, in a circular shape with a larger diameter than the weak point 24 itself.

In further embodiments, the stamping surface can be provided with a pattern or the like, such that an imprint with a corresponding pattern, as shown, for example, in FIGS. 3A-C, can be produced on the surface of the pressed region. For this purpose, the stamping surface can, for example, have elevations and/or depressions in the form of parallel and/or intersecting grooves, lines, etc. Furthermore, such elevations and/or depressions on the stamping surface can be curved.

FIG. 1D depicts the surface portion 20 with the region 22, which has a breakable weak point 24, after pressing. The region 22 is compressed with respect to the rest of the surface portion 20 and has a small layer thickness. The elevations or accumulations of material through the cut are flattened. In addition, the compression of the material presses the surfaces 28 against one another, such that a force-fitting connection is created between the surfaces 28. In order to achieve a force-fitting connection and to prevent a compensating movement of the fiber-containing material, the stamping surface or stamping region should preferably be dimensioned accordingly, e.g., be wide. Due to the force-fitting connection, the weak point 24 is a sealing weak point, but at the same time is easily breakable or pierceable because there is no integral bond between fibers of the opposing surfaces 28. In addition, piercing (e.g., by means of a straw or the like) does not cause any uncontrolled tearing or other damage to the surface portion 20, because a “predetermined breaking point” is provided, and the weak point 24 has a region that is already completely separated.

FIGS. 2A-F depict schematic representations of the formation of weak points 24 in molded bodies 10, where the molded bodies 10 depicted in FIGS. 2A-F are designed as lids. The lids are made of a fiber-containing material. The lids or molded bodies 10 in FIG. 2A-2F have a three-dimensional structure with a circumferential edge 12, which can be placed on a cup and latched to a cup rim. In the middle, the lids have a substantially circular surface portion 20. The surface portion 20 can have various design features. For example, the surface portion 20 has a depression, as indicated schematically. Furthermore, the surface portion 20 of each of the lids or molded bodies 10 shown has a weak point 24, which has been produced according to a production process as described herein and thus has a separation point 26, which has been pressed after a punching step such that a force-fitting connection between separated surfaces 28 has been established in the separation region.

FIG. 2A depicts the formation of a weak point 24 with three converging cuts that are separated from one another by a central ridge 30. In this embodiment, the stamping region can extend beyond the ridge 30.

FIG. 2B depicts a modification, where the weak point 24 has four converging cuts that are separated from one another by a central ridge 30.

FIG. 2C depicts a modification of the embodiment in FIG. 2B, where the four converging cuts are divided by further ridges 30. The cuts or the individual regions that were previously completely cut and then pressed can have a larger extent such that, despite a larger piercing region (e.g., for straws with a large cross-section, which are used, for example, for thick drinks (milkshakes, etc.)), the weak point 24 has sufficient stability and at the same time can be easily pierced.

FIG. 2D depicts a modification of the embodiment in FIG. 2A, where a cut is also made between the outer ends of each cut, which have then been pressed. In such embodiments, the weak point 24 can be pierced across almost the entire surface or be separated from the rest of the surface portion 20.

FIG. 2E depicts a modification of the embodiment in FIG. 2B, where a cut is also made between the outer ends of each cut, which have then been pressed. Even in these kinds of embodiments, the weak point 24 can be pierced over almost the entire surface or be separated from the rest of the surface portion 20.

FIG. 2F depicts an embodiment with a substantially circular region 22 having a plurality of cuts that completely separate the fiber-containing material and have been subsequently pressed, where the individual cuts are separated by ridges 30. In one region, the surface portion surrounded by the cuts and the ridges 30 is connected to the rest of the surface portion 20, such that, after the weak point 24 in the region 22 has been broken or pierced, the surface detached from the rest of the surface portion 20 remains connected to the rest of the surface connected 20 via a type of hinge.

In the embodiments depicted in FIGS. 2A-F, the ridges 30 can be pressed together with the completely cut regions of the fiber-containing material.

FIGS. 3A-C depict schematic representations of a weak point 24 that is provided with an imprint 32. An imprint 32 can be introduced when pressing a previously cut region 22 of a fiber-containing material or a surface portion 20, for which purpose a stamping surface of a stamping punch 42 has a corresponding design and, for example, has a surface with depressions and/or elevations. An imprint 32 can partially produce a greater degree of compression in the region of depressions in the pressed region of the fiber-containing material, whereby the structure weakened by the cut is additionally strengthened. Furthermore, an additional force distribution in the force-fitting connection between the previously separated surface portions can be achieved beyond the separation point 26. In addition, a marking of the weak point 24 can also be provided, which further facilitates piercing, since the piercing point can be found quickly.

FIG. 3A depicts an imprint 32 having a plurality of parallel depressions inclined at approximately 45° to the separation point 26 and extending, for example, over the entire pressed region. FIG. 3B depicts an imprint 32 with multiple crossing depressions, each of which extends in parallel with and at 45° or 135° to the separation point 26. The depressions can also extend over the entire pressed region. FIG. 3C depicts an embodiment with simply crossed depressions, each of which extends in parallel with and at 45° or 135° to the separation point 26, where the depressions can extend over the entire pressed region and the intersection points of that lie in the separation point 26. In further embodiments, other patterns for an imprint 32 can also be used.

FIG. 4 is a sectional schematic view of a weak point 24 of a further embodiment, where the previously cut region 22 has been pressed into a flat region from both sides, such that the depression is formed on the opposite sides as a result of the pressing process. For example, pressing on both sides can reduce the depression on only one side such that it is not noticeable or less noticeable, where pressing can be the same as with one-sided pressing.

Although such depressions are generally barely visible, in further embodiments, pressing and thus the formation of a depression can take place on the side of a surface portion 20 that is not visible during use of the molded body 10. In the exemplary embodiment in FIGS. 2A-F, for example, pressing on the non-visible underside of the lid could be effective.

FIGS. 5A-B depict further schematic representations of the production of a weak point 24 in a region of a surface portion 20 of a molded body 10. In the embodiment shown, the tool is equipped with at least one stamping punch 42, which has a punching knife 40 that can be moved into a receptacle 41. The punching knife 40 can be pressed out of the receptacle 41 in the unactuated state, e.g., by means of a spring device (e.g., a pressure spring) or the like, and thus protrudes from the lower stamping surface of the stamping punch 42. Thus, as depicted in FIG. 5A, when the stamping punch 42 is moved downwards, a cut can first be produced in a surface portion 20 made of fiber-containing material. In a lower end position, the punching knife 40 has completely cut the fiber-containing material and strikes a counter-support 44 of a lower tool plate. The punching knife 40 has thus reached its end position and cannot be moved downwards any further. If the stamping punch 42 is now moved further downwards, as depicted schematically in FIG. 5B, the punching knife 40 is no longer moved to the same extent and in the same direction as the stamping punch 42, but is displaced relative to the stamping punch 42 and pressed into the receptacle 41. This can be done against the force of the spring device. When the stamping surface touches the fiber-containing material, the punching knife 40 is in its position in which it is received in the stamping punch 42 as far as possible and can, for example, be flush with the lower surface of the stamping region. Subsequently, the stamping punch 42 continues to be pressed against the fiber-containing material such that it is compressed in the region of the stamping surface, as described above, and the fiber-containing material is pressed together in a force-fitting manner in the region of the separation point 26.

After pressing, the stamping punch 42 moves back to its starting position, and the punching knife 40 can continuously emerge from the receptacle 41. In further embodiments, the displacement of the punching knife 40 relative to the stamping punch 42 and together with the stamping punch 42 can be mechanically coupled such that, for example, before the stamping surface of the stamping punch touches the fiber-containing material, the punching knife 40 is completely received in the receptacle 41, and can only emerge from the receptacle 41 again when the stamping surface has reached a definable distance from the fiber-containing material. This can be achieved, for example, via a transmission arrangement.

FIGS. 6A and 6B depict yet further schematic representations of an embodiment in the production of a weak point 24 in a region of a surface portion 20 of a molded body 10, where the fiber-containing material is cut through from two sides. For this purpose, for example, punching tools can be used that are designed as described in FIGS. 5A-B and, for example, have punching knives 40 that can be displaced relative to a stamping punch 42. As depicted schematically in FIG. 6B, the fiber-containing material in the region 22 with the separation point 26 can be compressed from both sides.

In the embodiments described above, a punching tool can have a plurality of tool elements, such that a plurality of weak points 24 can be simultaneously produced in a plurality of molded bodies 10. Furthermore, the geometry of the punching knives 40 shown is an example and can in particular be very thin. For example, punching knives 40 can have a width of approximately 0.5 to 3 mm, with the tip ideally being almost 0 mm wide. In further embodiments, punching knives 40 can, for example, have a point angle or cutting angle of approximately 30-60°. However, punching knives 40 can be designed differently depending upon requirements. For example, punching knives 40 can specifically be designed in great variety and can differ, for example, with respect to the grind (e.g., ground on one side, two sides, four sides, etc.). In addition, in other embodiments, punching knives 40 that have a rounded tip can also be used.

FIG. 7 is a schematic representation of a method 50 for producing breakable weak points 24 in molded bodies 10 made of a fiber-containing material.

The method involves provision 51 of a molded body 10. The provision 51 may include a forming step, where either forming 52 from a relatively dry fiber material (dry forming) or forming 53 from an aqueous fiber suspension (pulp) is carried out (wet forming).

In a so-called wet process, preforms made of a fiber-containing material can first be provided, which are then pressed under the action of heat. The preforms can be prepared in such a way that fibers are suctioned out of an aqueous solution (pulp), and three-dimensional preforms are formed that substantially already have the shape of the products to be manufactured. In addition, additives such as starch, chemical supplements, wax, etc., can be added to a pulp to influence the properties of the products to be manufactured (e.g., barrier properties) and the processability. The fibers can, for example, be natural fibers, such as cellulose fibers, or fibers from a fiber-containing original material (for example, waste paper). Since a fiber-containing pulp with natural fibers can be used as the starting material for the molded bodies 10, after being used, the molded bodies 10 produced can themselves once again be used as a starting material for producing molded bodies 10 or other products, or they can be composted, because they can usually be completely decomposed and do not contain any dangerous substances that are harmful to the environment.

In other embodiments, the preforms can be subjected to a pre-pressing step. The preforms are then pressed into three-dimensional molded bodies 10 in a hot-pressing device under pressure and the action of heat.

Furthermore, the molded bodies 10 can be formed from a loose cellulose web (airlaid) or a paper.

To produce a weak point 24, the previously produced molded body 10 is then introduced 54 into a tool that has means for producing weak points 24.

Thereafter, the molded body 10 made of fiber-containing material is punched at 55 or cut in at least one surface portion 20, where the fiber-containing material is completely cut in a region 22. Punching 55 can be carried out by relatively displacing two tool parts, e.g., a punching knife 40 and counter-support 44.

Subsequently, the previously completely separated region 22 is pressed at 56 using another tool component—for example, a stamping punch 42. Pressing 56 can be carried out in the same tool or in another tool. In addition, stamping can be carried out in the same station using a combined tool, as shown, for example, in FIGS. 5A-B and 6A-B, or with two different tools arranged in successive stations of a tool. Pressing 56 can be carried out by relatively displacing two tool parts, e.g., a stamping punch 42 and counter-support 44. During pressing 56, the layer thickness of the fiber-containing material in the region 22 with the separation point 26 or the cut is compressed relative to the remaining surface portion 20, such that the fiber-containing material is additionally compacted and pressed together in a force-fitting manner on opposite surfaces 28 in the region of the separation point 26.

Pressing 56 can be carried out at pressures in the range of 1 to 200 N/mm² depending upon the layer thickness of the unpressed fiber-containing material, the material type and composition, as well as the cutting length and width. In addition, in further embodiments, the temperature of the stamping surface of a stamping punch 42 can be controlled in order to improve the compression of the fiber-containing material in the region 22 with the separation point 26. Preferably, pressing 56 is carried out at temperatures of 50 to 150° C.

In further embodiments, the region 22 can optionally be moistened 60 after the punching 55 and before the pressing 56, where the region 22 can be dried during pressing 56 at correspondingly higher temperatures (e.g., between 90-150° C.). However, there is no integral bond, such that the advantage of the force-fitting connection of the weak point 24 is retained.

After or at the same time as the pressing 56, the separation point 26 can be stamped using a stamping punch 42, as described in FIGS. 3A-C, or a separate tool.

Subsequently, the molded body 10 provided with at least one weak point 24 can be ejected 57, and can then be subjected to post-treatment 58 in another device or in the same device. Post-treatment 58 may include, for example, lamination 59, printing, etc. In further embodiments, the molded bodies 10 can be treated in other ways after their production, in order to achieve certain properties.

The formation of molded bodies 10 can vary depending upon the desired shape. This makes it easy to produce gap-free weak points 24 in a wide variety of pulp-based, fiber-containing material products and can be used for various regions and purposes. The gap-free weak points 24 of the technical teaching disclosed herein are obtained by completely cutting a fiber-containing material and subsequent pressing of the completely cut region, where pressing extends beyond the separation point 26 in order to exert sufficient pressure on the separation point 26 by means of the adjacent regions. The surface that has to be pressed depends upon the design of the separation point 26 (length, cutting depth, e.g., thickness of the fiber layer) and the material used, as well as the stability and desired resistance to piercing or breaking of the weak point 24.

### LIST OF REFERENCE SIGNS

10 Molded body
12 Edge
20 Surface portion
22 Region
24 Weak point
26 Separation point
28 Surface
30 Ridge
32 Embossing
40 Punching knife
41 Receptacle
42 Stamping punch
44 Counter-support
50 Method
51-60 Method steps

1. A method for producing a breakable weak point in molded bodies made of fiber-containing material, comprising:
providing a molded body made of a fiber-containing material having at least one surface portion;
completely cutting at least one region of the at least one surface portion; and
pressing the at least one completely cut region, wherein the fiber-containing material in the at least one completely cut region is pressed against each other to create a connection in the at least one region that is weaker than a connection of the fiber-containing material in a remaining region of the at least one surface portion.

2. The method according to claim 1, wherein a layer thickness of the fiber-containing material is reduced in the at least one completely cut region.

3. The method according to claim 1, wherein the pressing does not integrally bond the fiber-containing material in the at least one completely cut region.

4. The method according to claim 1, wherein the pressing takes place at a temperature in a range of 5° C. to 250° C.

5. The method according to claim 1, wherein the pressing takes place at a pressure in range of 1 N/mm² to 200 N/mm².

6. The method according to claim 1, further comprising cutting a plurality of regions in the at least one surface portion, wherein the plurality of regions are separated from one another by fiber-containing material that is not cut.

7. The method according to claim 6, further comprising pressing the plurality of regions and the fiber-containing material separating the plurality of regions.

8. The method according to claim 1, further comprising laminating the at least one region and/or the at least one surface portion after pressing.

9. The method according to claim 1, wherein providing the molded body involves forming the fiber-containing material into a molded body.

10. The method according to claim 1, further comprising, after the at least one region has been cut and before the at least one completely cut region has been pressed, moistening the at least one completely cut region.

11. The method according to claim 1, wherein the at least one completely cut region is cut and/or pressed on opposite sides of the at least one surface portion.

12. The method according to claim 1, further comprising, during the pressing, stamping a pattern spanning the at least one completely cut region into a surface on at least one side.

13. A tool for producing a breakable weak point in molded bodies made of fiber-containing material, the tool having at least one cutting element and at least one punch, wherein the at least one cutting element is received in the at least one punch and is displaceable relative to the at least one punch, wherein, in order to produce a breakable weak point in a molded body, the at least one cutting element and the at least one punch are collectively displaceable and the at least one cutting element protrudes from the at least one punch, wherein, after at least one region of a fiber-containing material has been cut by the collective displacement of the at least one cutting element and the at least one punch, the at least one cutting element is configured to be held on at least one stop such that, upon further displacement of the at least one punch, a pressing surface of the at least one punch is pressed against the at least one region, and the at least one cutting element plunges into the at least one punch.

14. A molded body made of fiber-containing material, having at least one surface portion, wherein the at least one surface portion has at least one region having a breakable weak point, wherein the breakable weak point has a separation point with opposite surfaces, wherein the opposite surfaces of the separation point are produced by separating the fiber-containing material, and wherein the fiber-containing material is force-fittingly interconnected at the opposite surfaces of the separation point.

15. The molded body according to claim 14, wherein the at least one surface portion in the region with the breakable weak point has a smaller layer thickness than adjacent regions of the at least one surface portion.

16. The molded body according to claim 14, wherein the fiber-containing material is compressed to a greater degree in the at least one region of the breakable weak point than in adjacent regions of the at least one surface portion.
